(19) United States
(12) Patent Application Publication
(10) Pub. No.: US 2019/0153242 A1
(43) Pub. Date: May 23, 2019

(54) SOLUBLE NANOPARTICLE SOLUTION AND CAPACITOR PACKAGE STRUCTURE

(71) Applicant: APAQ TECHNOLOGY CO., LTD., Miaoli County (TW)

(72) Inventors: MING-TSUNG CHEN, CHANGHUA COUNTY (TW); YI-YING WANG, HSINCHU CITY (TW)

(21) Appl. No.: 15/857,174

(22) Filed: Dec. 28, 2017

(30) Foreign Application Priority Data
Nov. 22, 2017 (TW) 106140556

(51) Int. Cl. C09D 5/24; C09D 7/40; C09D 179/04; C09D 165/00; C09D 171/02; C09D 125/18; H01G 9/07; H01G 9/15; H01G 9/04

(52) U.S. Cl. CPC C09D 5/24; C09D 7/67; C09D 179/04; C09D 165/00; C08K 5/053; C09D 125/18; H01G 9/07; H01G 9/151; H01G 9/04; C09D 171/02

(57) ABSTRACT

The instant disclosure provides a soluble nanoparticle solution for a capacitor and a capacitor package structure including the same. The soluble nanoparticle solution at least includes a polyol, a glycol, a soluble nanoparticle and a dispersing agent. The polyol has a molecular weight ranging from 50 to 1000 g/mol, and the glycol has 2 to 8 carbon atoms.

### BACKGROUND

### 1. Technical Field

The instant disclosure relates to a composition for a capacitor and a package structure using the same, in particular, to a soluble nanoparticle solution for a capacitor and a package structure using the same.

### 2. Description of Related Art

Capacitors are widely used in consumer appliances, computers, power supplies, communication products and vehicles, and hence, are important elements for electronic devices. The main effects of capacitors are filtering, bypassing, rectification, coupling, decoupling and phase inverting, etc. Based on different materials and uses thereof, capacitors can be categorized into aluminum electrolytic capacitors, tantalum electrolytic capacitors, laminated ceramic capacitors and thin film capacitors. In the existing art, solid electrolytic capacitors have the advantages of small size, large capacitance and excellent frequency property and can be used in the decoupling of power circuits of central processing units. Solid electrolytic capacitors use solid electrolytes instead of liquid electrolytic solutions as cathodes. Conductive polymers are suitable for the cathode material of the capacitors due to its high conductivity, and the manufacturing process using conductive polymers are simple and low cost. However, the capacitors in the existing art have relatively high capacity loss under low temperature applications.

### SUMMARY

The main object of the instant disclosure is to provide a composition for a capacitor and a capacitor package structure using the same. The composition is able to improve the performance of the capacitor package structure in low temperature applications.

An embodiment of the instant disclosure provides a soluble nanoparticle solution for a capacitor, including a polyol, a glycol, a soluble nanoparticle and a dispersing agent. The polyol has a molecular weight ranging from 50 to 1000 g/mol, and the glycol has 2 to 8 carbon atoms.

In a preferred implementation of the instant disclosure, the polyol is polyethylene glycol or polypropylene glycol.

In a preferred implementation of the instant disclosure, the glycol is selected from the group consisting of sorbitol, xylitol, maltitol, heptan-3-ol, heptan-4-ol, heptan-5-ol, heptan-6-ol, heptan-7-ol and any combination thereof.

In a preferred implementation of the instant disclosure, the soluble nanoparticle is selected from the group consisting of aniline, polypyrrole, polythiophene, polydioxythiophene-polystyrenesulfonic acid and any combination thereof.

In a preferred implementation of the instant disclosure, the percentage of the polyol in the soluble nanoparticle solution is from 2 to 50 wt. %.

In a preferred implementation of the instant disclosure, the percentage of the glycol in the soluble nanoparticle solution is from 0.5 to 50 wt. %.

In a preferred implementation of the instant disclosure, the combined percentage of the polyol and the glycol in the soluble nanoparticle solution is from 5 to 55 wt. %.

Another embodiment of the instant disclosure provides a capacitor package structure employing a conductive foil at least having a soluble nanoparticle coating. The soluble nanoparticle coating includes a polyol, a glycol, a soluble nanoparticle and a dispersing agent. The polyol has a molecular weight ranging from 50 to 1000 g/mol, and the glycol has 2 to 8 carbon atoms.

In a preferred implementation of the instant disclosure, the soluble nanoparticle coating is formed on the conductive foil under a humidity of less than 60 degrees and a temperature ranging from 60 to 180° C.

In a preferred implementation of the instant disclosure, the capacitor package structure has a capacity loss of less than 20% under an operation temperature ranging from −55 to 120° C.

The advantage of the instant disclosure resides in that the soluble nanoparticle solution for a capacitor and a package structure using the same can reduce the capacity loss under low temperature applications, reduce the risk of short circuit and increase the reliability of the product, thereby improving the electrical properties and performance related thereto based on the technical feature of “the soluble nanoparticle coating includes a polyol, a glycol, a soluble nanoparticle and a dispersing agent” and “the polyol has a molecular weight ranging from 50 to 1000 g/mol, and the glycol has 2 to 8 carbon atoms”.

In order to further understand the techniques, means and effects of the instant disclosure, the following detailed descriptions and appended drawings are hereby referred to, such that, and through which, the purposes, features and aspects of the instant disclosure can be thoroughly and concretely appreciated; however, the appended drawings are merely provided for reference and illustration, without any intention to be used for limiting the instant disclosure.

### BRIEF DESCRIPTION OF THE DRAWINGS

The accompanying drawings are included to provide a further understanding of the instant disclosure, and are incorporated in and constitute a part of this specification. The drawings illustrate exemplary embodiments of the instant disclosure and, together with the description, serve to explain the principles of the instant disclosure.

FIG. 1 is a sectional schematic view of a capacitor package structure provided by an embodiment of the instant disclosure.

FIG. 2 is a sectional schematic view of a capacitor element of the capacitor package structure provided by the embodiment of the instant disclosure.

FIG. 3 shows a comparison of the capacity loss between a capacitor package structure in the existing art and a capacitor package structure provided by the embodiment of the instant disclosure under a same operating condition.

### DESCRIPTION OF THE EXEMPLARY EMBODIMENTS

Reference will now be made in detail to the exemplary embodiments of the instant disclosure, examples of which are illustrated in the accompanying drawings. Wherever possible, the same reference numbers are used in the drawings and the description to refer to the same or like parts.

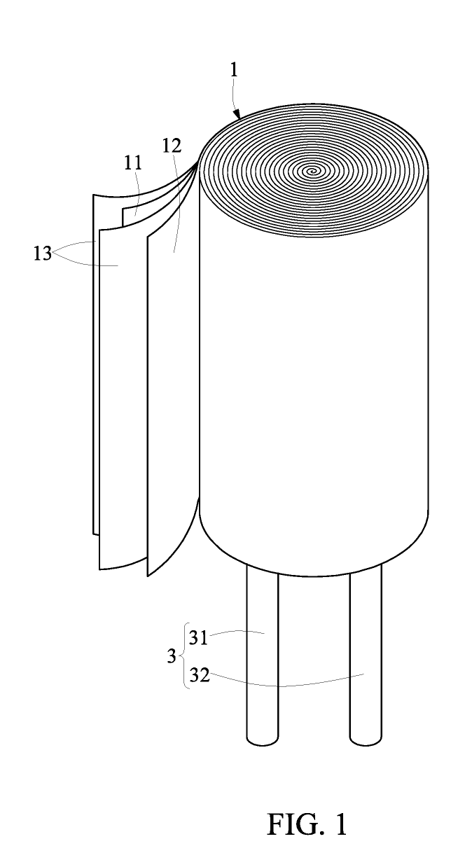

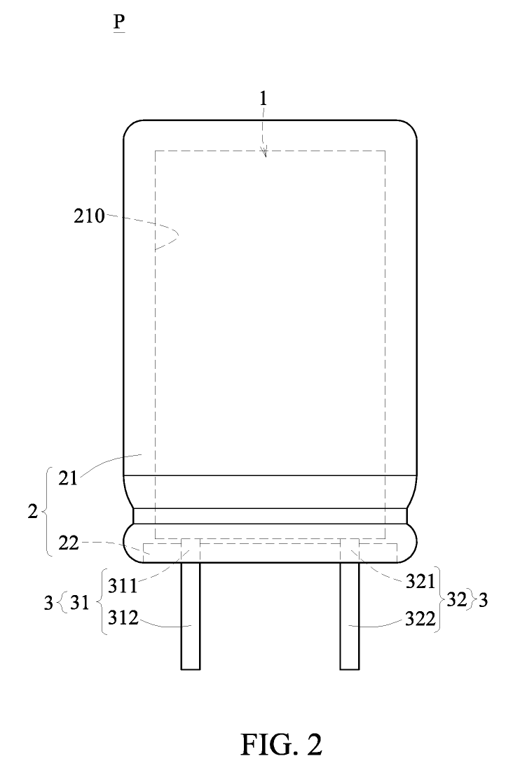

Reference is made to FIG. 1 and FIG. 2. FIG. 1 is a sectional schematic view of a capacitor package structure provided by an embodiment of the instant disclosure, and FIG. 2 is a sectional schematic view of a capacitor element of the capacitor package structure provided by the embodiment of the instant disclosure.

As shown in FIG. 1, the capacitor package structure P includes a winding-type component 1, a packaging component 2 and a conductive component 3. The winding-type component 1 and the conductive component 3 together form the capacitor element used in the instant disclosure. The winding-type component 1 includes a winding-type positive conductive foil 11, a winding-type negative conductive foil 12 and two isolating foils 13. Furthermore, one of the two isolating foils 13 can be disposed between the winding-type positive conductive foil 11 and the winding-type negative conductive foil 12, and one of the winding-type positive conductive foil 11 and the winding-type negative conductive foil 12 can be disposed between the two isolating foils 13. In the embodiments of the instant disclosure, a soluble nanoparticle solution is disposed on the winding-type positive conductive foil 11 of on the winding-type negative conductive foil 12 by a coating process for forming a soluble nanoparticle coating.

For example, the soluble nanoparticle solution provided by the embodiments of the instant disclosure can be disposed on the surface or in the inner portion of the winding-type component 1 and can immerse into the vias on the surface of the winding-type component 1. In the embodiments of the instant disclosure, the soluble nanoparticle solution is disposed on the winding-type positive conductive foil 11 or the winding-type negative conductive foil 12 including titanium (Ti) or Carbon (C).

As shown in FIG. 2, the winding-type component 1 can be enclosed in the packaging component 2. For example, the packaging component 2 includes a capacitor casing structure 21 (such as an aluminum casing or casing made of other metals) and a bottom end sealing structure 22. The capacitor casing structure 21 has an accommodating space 210 for accommodating the winding-type component 1, and the bottom end sealing structure 22 is disposed at the bottom end of the capacitor casing structure 21 for sealing the accommodating space 210. In addition, the packaging component 2 can be a packaging body made of any insulating materials.

The conductive component 3 includes a first conductive pin 31 electrically contacting with the winding-type positive conductive foil 11 and a second conductive pin 32 electrically contacting the second conductive pin 32. For example, the first conductive pin 31 has a first embedded portion 311 enclosed in the packaging component 2 and a first exposed portion 312 exposed from the packaging component 2. The second conductive pin 32 has a second embedded portion 321 enclosed in the packaging component 2 and a second exposed portion 322 exposed from the packaging component 2.

Next, the composition of the soluble nanoparticle solution for capacitors provided by the embodiments of the instant disclosure is described herein. The soluble nanoparticle solution employed on the winding-type component 1 of the capacitor package structure P can form current conducting paths between the winding-type positive conductive foil 11 and the winding-type negative conductive foil 12. By adjusting and selecting the components and the ratio thereof in the soluble nanoparticle solution, the performance of the capacitor package structure P in harsh environments, such as under low temperature, can be improved.

Specifically, the soluble nanoparticle solution at least includes a polyol, a glycol, a soluble nanoparticle and a dispersing agent. In a preferred embodiment, the polyol has a molecular weight of from 200 to 800 g/mol, preferably from 200 to 600 g/mol. The polyol can be polyethylene glycol or polypropylene glycol. In the soluble nanoparticle solutions, the polyol is used for performing secondary doping, thereby increasing the conductivity of the soluble nanoparticle coating formed by the soluble nanoparticle solution.

In addition, in the instant disclosure, the glycol has 2 to 8 carbon atoms. For example, the glycol can be sorbital, xylitol, maltitol, heptan-3-ol, heptan-4-ol, heptan-5-ol, heptan-6-ol, heptan-7-ol or any combination thereof. In the soluble nanoparticle solution, the glycol can be used to perform secondary doping for increasing the soluble nanoparticle coating formed by the soluble nanoparticle solution.

In the soluble nanoparticle solution provided by the instant disclosure, the percentage of the polyol is from 2 to 50 wt. %, preferably from 2 to 50 wt. %. When the percentage of the polyol is less than 2 wt. %, the degree of the secondary doping of the soluble nanoparticle is insufficient; and when the percentage of the polyol is more than 50 wt. %, the solid content of the soluble nanoparticle decreases, thereby producing detrimental effects towards the conductivity and the element reliability of the capacitor element.

In the soluble nanoparticle solution provided by the instant disclosure, the percentage of the glycol is from 0.5 to 50 wt. %, preferably from 0.5 to 25 wt. %. When the percentage of the glycol is less than 0.5 wt. %, the element reliability is reduced; and when the percentage of the glycol is more than 50 wt. %, the solid content of the soluble nanoparticle solution is reduced and the overall property of the soluble nanoparticle solution is reduced.

In addition to the adjustment and selection regarding the percentage of each of the polyol and the glycol in the soluble nanoparticle solution, the combined percentage of the polyol and the glycol in the soluble nanoparticle solution is selected to be from 5 to 55 wt. % (based on the total weight of the soluble nanoparticle solution). Specifically, the quality of performance of the capacitor using the soluble nanoparticle solution under specific applications can be ensured by controlling the amount of each of the polyol and the glycol, and the combined percentage of the polyol and the glycol.

For example, if the combined percentage of the polyol and the glycol is more than 20 wt. % based on the total weight of the soluble nanoparticle solution, the capacitor package structure employing the soluble nanoparticle solution may have significantly reduced capacitance under low temperature applications.

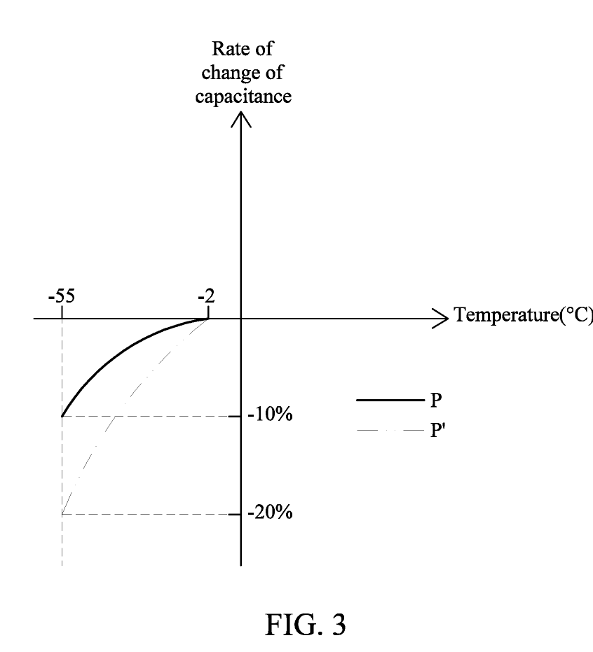

Reference is made to FIG. 3. FIG. 3 shows a comparison of the capacity loss between a capacitor package structure in the existing art and a capacitor package structure provided by the embodiment of the instant disclosure under a same operating condition. The operating condition (testing condition) used in FIG. 3 is from 24 to 200 hours.

As shown in FIG. 3, the capacitor package structure P employing the soluble nanoparticle solution provided by the instant disclosure has a capacity loss of about 10% in a −2 to −55° C. environment. On the other hand, the capacitor package structure P′ in the existing art has a capacity loss of about −20° C. under a same condition.

As mentioned above, the soluble nanoparticle solution is mainly used for providing the electrical conducting paths in the capacitor package structure P. Therefore, the soluble nanoparticle included in the soluble nanoparticle solution is a conductive material. The soluble nanoparticle can be selected from the group consisting of aniline, polypyrrole, polythiophene, polydioxythiophene-polystyrenesulfonic acid and any combination thereof. In addition, the soluble nanoparticle can be a conductive material subjected to surface modifications or surface treatments. For example, the materials listed above, i.e., aniline, polypyrrole, polythiophene, polydioxythiophene-polystyrenesulfonic acid and any combination thereof, can be modified by nano-materials (such as nano-carbon materials) or emulsifiers. In addition, the conductive material can be subjected to secondary doping for increasing the performance of the soluble nanoparticle.

In the soluble nanoparticle solution, the particle size of the soluble nanoparticle is from 5 to 40 nanometers (nm). In the instant disclosure, the type, property and the content of the soluble nanoparticle are not limited.

The soluble nanoparticle solution of the instant disclosure can be disposed on the conductive foils (the winding-type positive conductive foil 11 and/or the winding-type negative conductive foil 12) of the capacitor element by a coating process. For example, the coating process includes but is not limited to immersing, spin-coating, curtain coating or spray-coating for coating the soluble nanoparticle solution on the capacitor element, thereby forming a soluble nanoparticle layer. Preferably, the capacitor element is immersed into a vessel (container) containing the soluble nanoparticle solution for disposing the soluble nanoparticle solution on the surface of the capacitor element and enabling the soluble nanoparticle solution to immerse into the plurality of vias (pores) of the capacitor element. The plurality of vias of the capacitor element can be formed by defect during the manufacturing process of the winding-type component 1.

It should be noted that the step of coating the soluble nanoparticle solution is performed under a humidity of less than 60 degrees and a temperature of from 60 to 180° C. In other words, the soluble nanoparticle solution is formed on the isolating foil 13 under a specific humidity and temperature. Therefore, it can be ensured that the capacitor package structure P would have good electrical properties under low-temperature applications.

### Effectiveness of the Embodiments

One of the advantages of the instant disclosure resides in that the soluble nanoparticle solution for a capacitor and a package structure P using the same can reduce the capacity loss under low temperature applications, reduce the risk of short circuit and increase the reliability of the product, thereby improving the electrical properties and performance related thereto of the capacitor package structure based on the technical feature of “the soluble nanoparticle coating includes a polyol, a glycol, a soluble nanoparticle and a dispersing agent” and “the polyol has a molecular weight ranging from 50 to 1000 g/mol, and the glycol has 2 to 8 carbon atoms”.

The above-mentioned descriptions represent merely the exemplary embodiment of the present disclosure, without any intention to limit the scope of the instant disclosure thereto. Various equivalent changes, alterations or modifications based on the claims of the instant disclosure are all consequently viewed as being embraced by the scope of the instant disclosure.

What is claimed is:

1. A soluble nanoparticle solution for capacitor, comprising a polyol, a glycol, a soluble nanoparticle and a dispersing agent, wherein the polyol has a molecular weight ranging from 50 to 1000 g/mol, and the glycol has 2 to 8 carbon atoms.

2. The soluble nanoparticle solution for capacitor according to claim 1, wherein the polyol is polyethylene glycol or polypropylene glycol.

3. The soluble nanoparticle solution for capacitor according to claim 1, wherein the glycol is selected from the group consisting of sorbitol, xylitol, maltitol, heptan-3-ol, heptan-4-ol, heptan-5-ol, heptan-6-ol, heptan-7-ol and any combination thereof.

4. The soluble nanoparticle solution for capacitor according to claim 1, wherein the soluble nanoparticle is selected from the group consisting of aniline, polypyrrole, polythiophene, polydioxythiophene-polystyrenesulfonic acid and any combination thereof.

5. The soluble nanoparticle solution for capacitor according to claim 1, wherein the percentage of the polyol in the soluble nanoparticle solution is from 2 to 50 wt. %.

6. The soluble nanoparticle solution for capacitor according to claim 1, wherein the percentage of the glycol in the soluble nanoparticle solution is from 0.5 to 50 wt. %.

7. The soluble nanoparticle solution for capacitor according to claim 1, wherein the combined percentage of the polyol and the glycol in the soluble nanoparticle solution is from 5 to 55 wt. %.

8. A capacitor package structure employing a conductive foil at least having a soluble nanoparticle coating, wherein the soluble nanoparticle coating comprises a polyol, a glycol, a soluble nanoparticle and a dispersing agent, wherein the polyol has a molecular weight ranging from 50 to 1000 g/mol, and the glycol has 2 to 8 carbon atoms.

9. The capacitor package structure according to claim 8, wherein the soluble nanoparticle coating is formed on the conductive foil under a humidity of less than 60 degrees and a temperature ranging from 60 to 180° C.

10. The capacitor package structure according to claim 8, wherein the capacitor package structure has a capacity loss of less than 20% under an operation temperature ranging from −55 to 120° C.
